(19) United States
(12) Patent Application Publication
(10) Pub. No.: US 2024/0135326 A1
(43) Pub. Date: Apr. 25, 2024

(54) INFORMATION PROCESSING DEVICE, PROGRAM, AND INFORMATION PROCESSING METHOD

(71) Applicant: JIYU LABORATORIES, INC., Tokyo (JP)

(72) Inventor: Yasutomo TAKANO, Tokyo (JP)

(73) Assignee: JIYU LABORATORIES, INC., Tokyo (JP)

(21) Appl. No.: 18/546,464

(22) PCT Filed: Feb. 28, 2022
(86) PCT No.: PCT/JP2022/008310

§ 371 Date: Aug. 14, 2023

(30) Foreign Application Priority Data
Mar. 10, 2021 (JP) 2021-038714

(51) Int. Cl. G06Q 10/10; G06F 16/34; G06Q 10/0639

(52) U.S. Cl. CPC G06Q 10/103; G06F 16/345; G06Q 10/0639

(57) ABSTRACT

An information processing unit is provided that records necessary information for each phase of a project to facilitate understanding. The information management system to manage information on projects in a team is provided, the system including: a storage section; a display screen; a data registration section; and a display control section, wherein the data registration section is configured to register data on a plurality of phases chronologically proceeding in each project conducted by a respective member in the team in association with recorded data recorded by the member for the respective phases in the storage section, and the display control section is configured to display the recorded data on the display screen in a tree structure associated with the phases.

### TECHNICAL FIELD

The present invention relates to an information processing unit, a program, and an information processing method.

### BACKGROUND ART

In recent years, information processing units to manage projects have been developed. For example, PTL 1 discloses an information processing unit and a program management program to inform a user using software at an appropriate timing of help information.

### CITATION LIST

### Patent Literature

PTL 1: JP 2017-076447 A

### SUMMARY OF INVENTION

### Technical Problem

Meanwhile, in a project team to proceed with a project by a plurality of members, there is a need for recording necessary information for each phase of the project by the individual members to facilitate understanding.

It is an object of the present invention to provide an information processing unit that records necessary information for each phase of a project to facilitate understanding.

### Solution to Problem

An information management system to manage information on projects in a team is provided, the system including: a storage section; a display screen; a data registration section; and a display control section, wherein the data registration section is configured to register data on a plurality of phases chronologically proceeding in each project conducted by a respective member in the team in association with recorded data recorded by the member for the respective phases in the storage section, and the display control section is configured to display the recorded data on the display screen in a tree structure associated with the phases.

Such a configuration allows each member in the team to register recorded data in association with a phase of a project in charge. The recorded data is then displayed in a tree structure associated with the phase, and thus each member is capable of readily understanding the recorded data necessary for each phase.

### BRIEF DESCRIPTION OF DRAWINGS

FIG. 1 illustrates an overview of an information management system 100 according to a first embodiment.

FIG. 2 is a block diagram illustrating a hardware configuration of an information processing unit 10 according to the first embodiment.

FIG. 3 is a block diagram illustrating a hardware configuration of a user terminal 20 according to the first embodiment.

FIG. 4 is a block diagram illustrating a functional configuration of the information processing unit 10 according to the first embodiment.

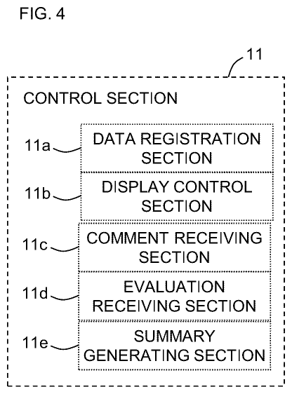

FIG. 5 illustrates a Sign In screen S of the information management system 100.

FIG. 6 illustrates a My Research screen ST1.

FIG. 7 illustrates a display of details of a phase icon 33 in the My Research screen ST1.

FIG. 8 illustrates a note display screen ST2.

FIG. 9 illustrates a summary display screen ST3.

FIG. 10 illustrates an archive list screen ST4.

FIG. 11 illustrates an archive check screen ST5.

FIG. 12A illustrates a student list screen SV1 displayed in a list. FIG. 12B illustrates the student list screen SV1 displayed in a grid.

FIG. 13 illustrates a progress check screen SV2.

FIG. 14 illustrates a display of details of a phase icon 33 in the progress check screen SV2.

FIG. 15 illustrates a note display screen SV3.

FIG. 16 is a sequence diagram illustrating a process flow of the information management system 100.

FIG. 17 illustrates a My Research screen ST1 in a first modification.

FIG. 18 illustrates a My Research screen ST1 in a second modification.

FIG. 19 illustrates My Research screens ST1 in a third modification.

### DESCRIPTION OF EMBODIMENTS

With reference to the drawings, a description is given below to some embodiments of the present invention. Various characteristics in the embodiments described below may be combined with each other. Each characteristic is independently inventive.

### 1. FIRST EMBODIMENT

### 1-1. Information Management System 100

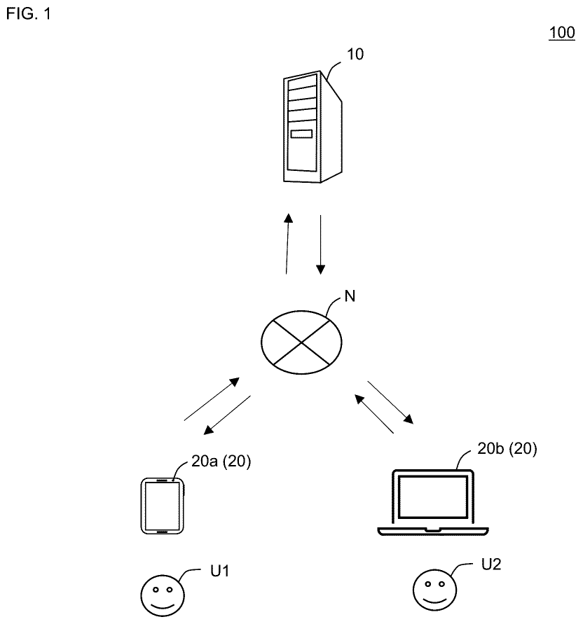

An information management system 100 according to an embodiment of the present invention is provided with, as illustrated in FIG. 1, an information processing unit 10 and a user terminal 20. The information processing unit 10 and the user terminal 20 are connected to a network N, such as the internet, for example, and configured to allow communication with each other.

An example of the user terminal 20 may be a smartphone terminal 20a or may be a PC terminal 20b. Users U1 and U2 are capable of accessing the information processing unit 10 to use the information management system 100 by operating the user terminal 20.

The information management system 100 according to the present embodiment is a system to manage information on projects in a team. The present embodiment assumes to use for information management in a team, such as a laboratory of a university. Students in the laboratory access the information management system 100 to manage information necessary for research activities as the projects conducted by themselves. The supervisor of the laboratory accesses the information management system 100 to check on the progress of the research activities of a student supervised by him/herself. The function of each configuration is detailed below.

### 1-2. Hardware Configuration of Information Management System 100

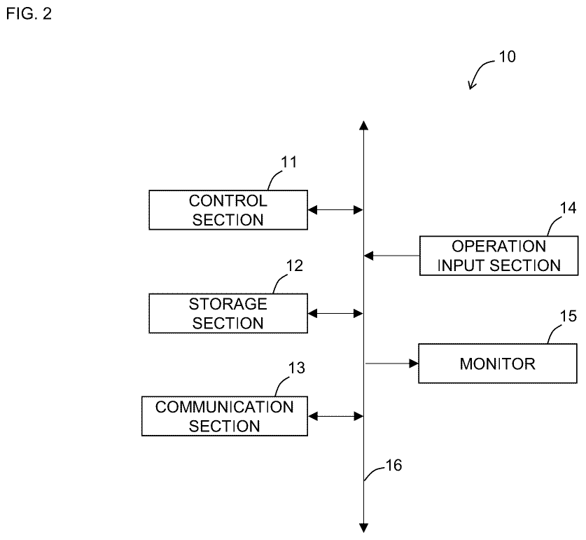

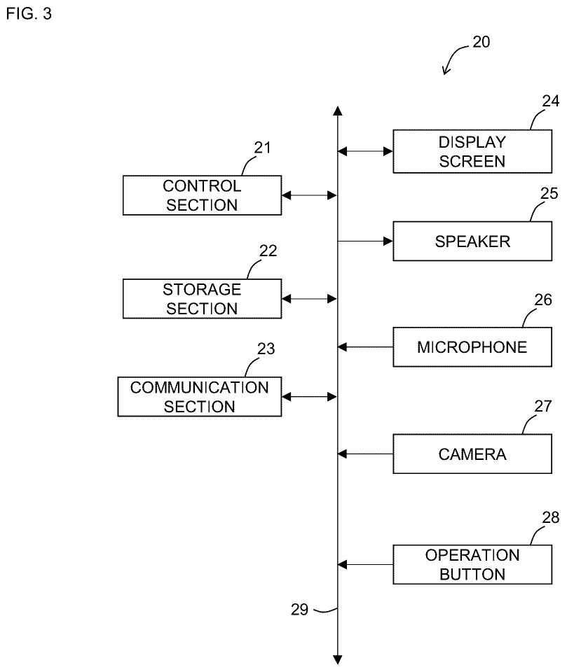

With reference to FIGS. 2 and 3, a description is given to the hardware configuration of the information management system 100.

### 1-2-1. Hardware Configuration of Information Processing Unit 10

FIG. 2 is a block diagram illustrating the hardware configuration of the information processing unit 10. The information processing unit 10 is provided with a control section 11, a storage section 12, and a communication section 13. The information processing unit 10 may also be provided with an operation input section 14 configured with a keyboard, a mouse, and the like and configured to receive inputs of various kinds of operation and a monitor 15, such as a liquid crystal display device, for example, configured to display various images.

The control section 11 is, for example, a CPU (central processing unit), a microprocessor, a DSP (digital signal processor), and the like and is configured to control the behavior of the entire information processing unit 10.

The storage section 12 is partially configured with, for example, a RAM (random access memory), a DRAM (dynamic random-access memory), and the like and is configured to be used as a work area during execution of process based on various programs by the control section 11 and the like. In addition, the storage section 12 is partially a nonvolatile memory, such as a ROM (read only memory), for example, or an HDD (hard disk drive) to save various kinds of data, programs used for process of the control section 11, and the like.

The programs stored in the storage section 12 are, for example, an OS (operating system) to achieve basic functions of the information processing unit 10, drivers to control various kinds of hardware, programs to achieve various functions, and the like and includes a computer program according to the present embodiment.

The communication section 13 is, for example, an NIC (network interface controller) and has a function of connecting to the network N. It should be noted that the communication section 13 may have a function of connecting to a wireless LAN (Local Area Network) instead of or together with the NIC, a function of connecting to a wireless WAN (Wide Area Network), and a function of allowing short distance wireless communication, such as Bluetooth®, for example, infrared communication, and the like. The information processing unit 10 is connected to another information processing unit, such as the user terminal 20, and the like via the network N to allow transmission and reception of various kinds of data to and from such another information processing unit and the like.

The control section 11, the storage section 12, the communication section 13, the operation input section 14, and the monitor 15 are electrically connected to each other via a system bus 16. Accordingly, the control section 11 is capable of performing access to the storage section 12, display of an image on the monitor 15, understanding of a state of operating the operation input section 14 by an operator, access to various communication networks and other information processing units via the communication section 13, and the like.

### 1-2-2. Hardware Configuration of User Terminal 20

FIG. 3 is a block diagram illustrating the hardware configuration of the user terminal 20 according to the present embodiment. The user terminal 20 is an information processing terminal achieved by, for example, a smartphone, a tablet, or a PC and is provided with a control section 21, a storage section 22, and a communication section 23. The user terminal 20 may also be provided with a display screen 24, such as a touch screen display displaying an image and the like and capable of receiving operation, a speaker 25 configured to output sound, a microphone 26 configured to input sound, a camera 27 configured to image a subject, and an operation button 28. The following description is mainly given to differences from the information processing unit 10.

The operation button 28 is provided on a side surface of the user terminal 20 and the like and is a power button to start or stop the user terminal 20, a volume control button for sound output from the speaker 25, and the like.

The control section 21, the storage section 22, the communication section 23, the display screen 24, the speaker 25, the microphone 26, the camera 27, and the operation button 28 are electrically connected to each other via a system bus 29. Accordingly, the control section 21 is capable of performing access to the storage section 22, display of an image on the display screen 24, understanding of a state of operating the touch screen display (display screen 24) and the operation button 28 by a user, input of sound to the microphone 26, output of sound from the speaker 25, control over the camera 27, access to various communication networks and other information processing units, such as the information processing unit 10, via the communication section 23, and the like.

### 1-3. Functional Configuration of Information Processing Unit 10

As illustrated in FIG. 3, the control section 11 of the information processing unit 10 is provided with a data registration section 11a, a display control section 11b, an evaluation receiving section 11d, and a summary generating section 11e.

The data registration section 11a registers data on a plurality of phases chronologically proceeding in each research activity (equivalent to “project” in the claims) conducted by a respective student (equivalent to the “member” in the claims) in the laboratory (equivalent to the “team” in the claims) in association with recorded data recorded by the student for the respective phases in the storage section 12.

The display control section 11b displays the recorded data registered in the storage section 12 on the display screen 24 of the user terminal 20 in a tree structure associated with the phases. A comment receiving section 11c receives a comment on the recorded data from a person in charge of the project and a comment on the recorded data from a supervisor supervising the project.

The evaluation receiving section 11d receives evaluation on the recorded data recorded by the student from the members in the team. The summary generating section 11e generates a summary of a literature specified by the members. The details of each function are described later.

The functional configuration described above may be achieved by software (including so-called application) appropriately installed in the information processing unit 10 or may be achieved by hardware. If the configuration is achieved by software, the control section 11 is capable of achieving various functions by executing a program constituting the software.

The program may be stored in the storage section 12 built in the information processing unit 10 or may be stored in a computer-readable non-transitory storage medium. As another example, the program may be achieved by reading a program stored in an external storage device, so-called cloud computing. If the configuration is achieved by hardware, the hardware may be achieved by various kinds of circuit, such as ASIC, SOC, FPGA, or DRP.

### 1-4. Screen Display of Information Management System 100

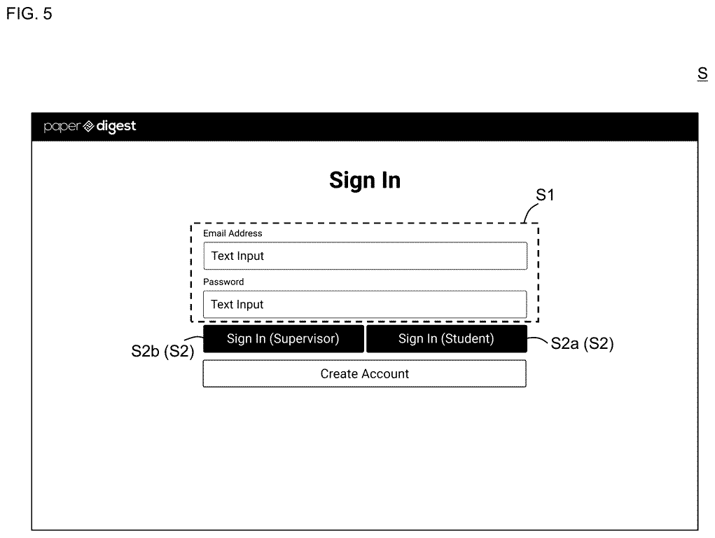

With reference to FIGS. 5 through 16, a description is given to screen display of the information management system 100. FIG. 5 illustrates a Sign In screen S of the information management system 100.

As illustrated in FIG. 5, a user is capable of signing in the information management system 100 by inputting necessary items in an input area S1 of the Sign In screen S and pressing a Sign in button S2. It should be noted that the Sign in button S2 includes a Sign in button S2a for students and a Sign in button S2b for supervisor. In the following description, the user U1 is assumed to be a student and the user U2 is assumed to be the supervisor.

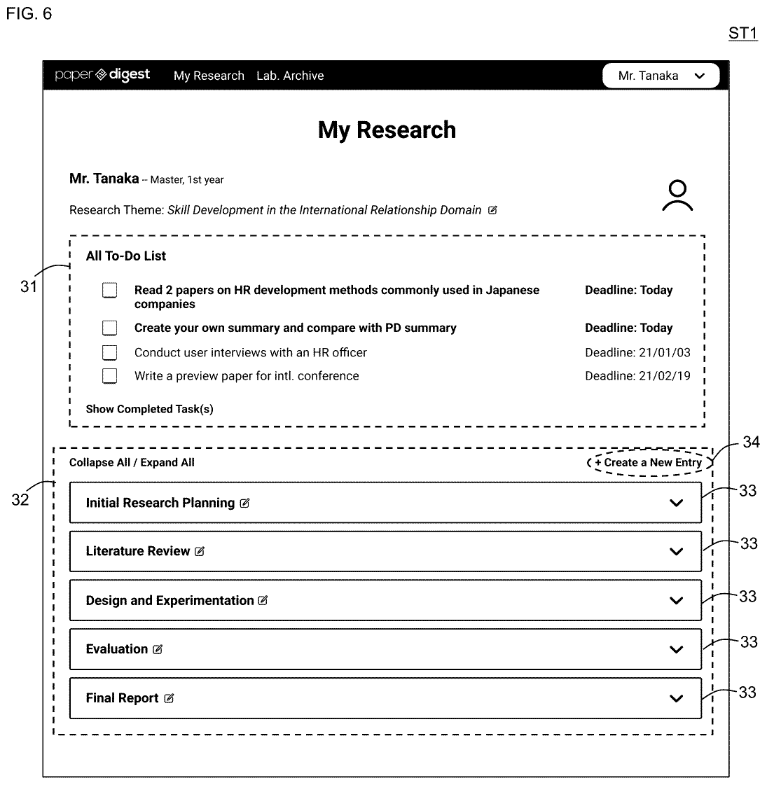

At first, with reference to FIGS. 6 through 11, the case that the user U1 as the student signs in is described. FIG. 6 illustrates a My Research screen ST1 equivalent to the top screen when a student signs in.

As illustrated in FIG. 6, the My Research screen ST1 is provided with a task list 31 and a phase area 32. The task list 31 chronologically displays a list of tasks assigned to the user U1 at that timing in the research activity.

In the phase area 32, a plurality of phase icons 33 are displayed. The phase icons 33 represent phases chronologically proceeding in the research activity. The user U1 is capable of arbitrarily setting a necessary phase in the research activity by pressing a phase generation button 34. When each of the phase icons 33 is pressed, the details are displayed.

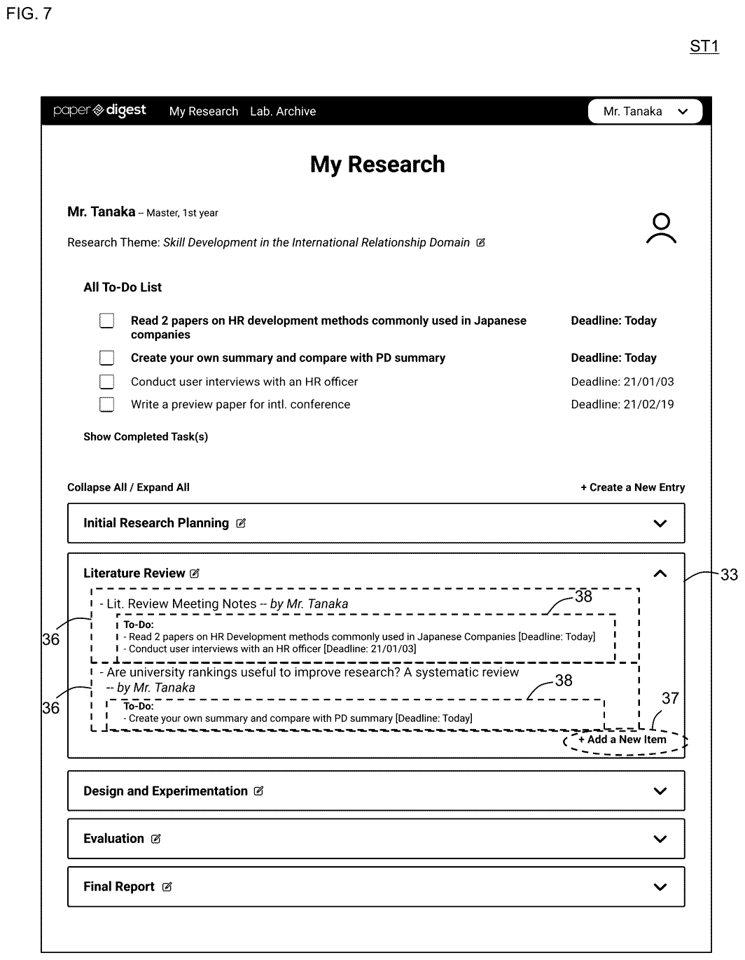

FIG. 7 illustrates a display of the details of one of the phase icons 33. The phase icon 33 includes a note icon 36 and a note addition button 37. The note icon 36 indicates a note that is recorded data recorded by the student in the phase. The note includes data on the details of the research contents and related papers. The note icons 36 are displayed in a tree structure associated with the phase. It should be noted that the tree structure means a structure where data items are arranged to be branched by arranging a plurality of child data items are associated with one parent data item.

The user U1 is capable of registering related recorded data for the respective phases of the research activity by pressing the note addition button 37. The information management system 100 thus allows necessary information to be registered as the recorded data for each chronologically proceeding phase and to be displayed in a tree structure corresponding to the phase, and accordingly allows the user U1 to readily understand necessary data in the own research.

In addition, the note icons 36 display the tasks to be performed by the user U1 in the phase associated with the recorded data in task areas 38. Such a configuration allows the user U1 to check on the tasks necessary for each phase. When the user U1 presses the note icon 36, the details of the note are displayed.

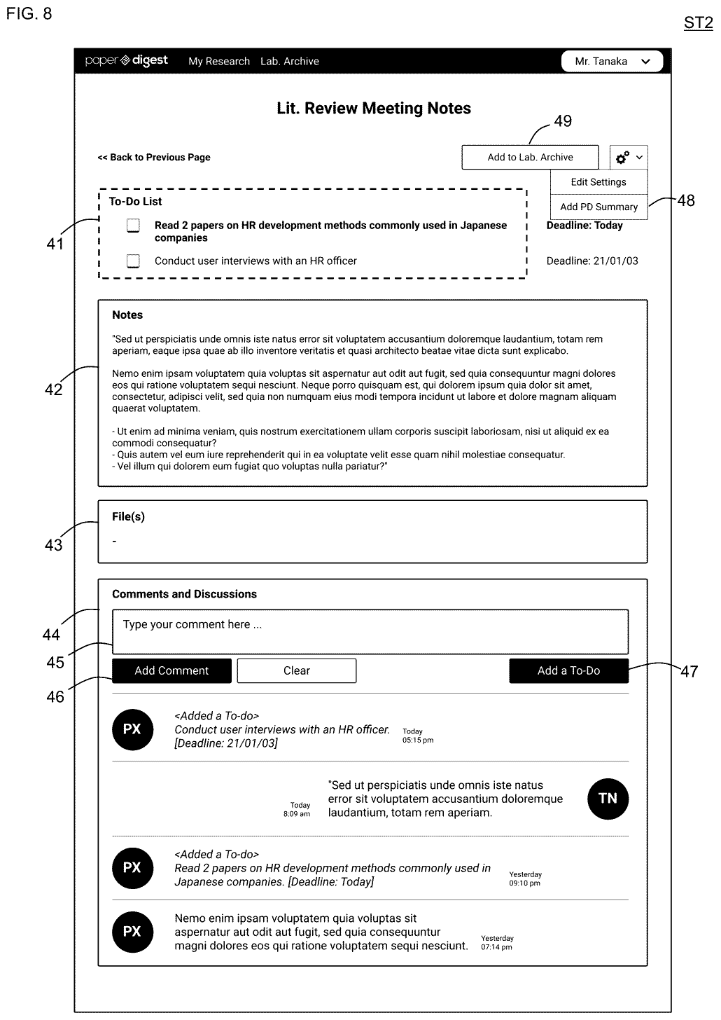

FIG. 8 illustrates a note display screen ST2. As illustrated in FIG. 8, the note display screen ST2 includes a task area 41, a note area 42, a file area 43, a comment area 44, a summary button 48, and an archive addition button 49.

In the task area 41, the tasks described in the note are displayed. In the note area 42, the contents of the note are displayed. Specifically, experimental results, considerations, reviews, and the like in the research activity are described.

In the file area 43, files of papers added to the note and the like are displayed. In the comment area 44, comments on the note are displayed.

In the comment area 44, comments from the user U1 as the student in charge of the research activity and comments from the user U2 as the supervisor supervising the research activity are displayed. The user U1 is capable of adding a comment at any time by entering a comment in a comment input field 45 and pressing an addition button 46. In addition, the user U1 is capable of adding a task at any time by pressing a task addition field 47. When the user U1 presses the summary button 48, a summary of a paper added to the file area 43 is displayed.

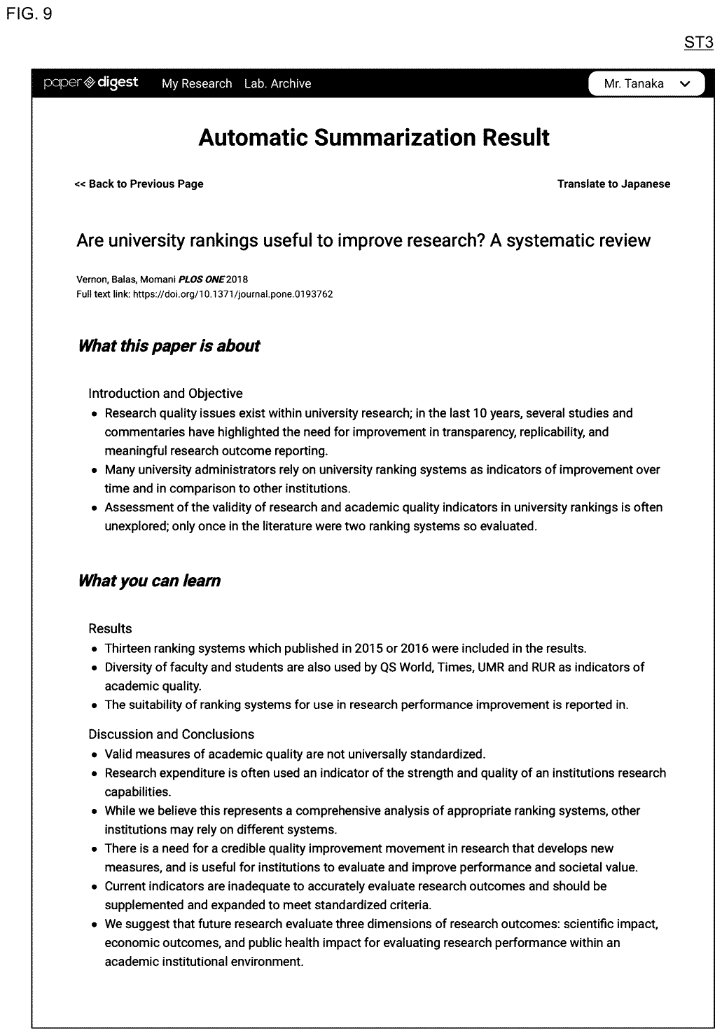

FIG. 9 illustrates a summary display screen ST3. The summary generating section 11e generates a summary of the literature displayed in the file area 43 and specified by the member. In this situation, the summary display screen ST3 generates a summary considering the phase to which the note belongs.

In addition, when the user U1 presses the archive addition button 49 in the note display screen ST2, the note is added to an archive.

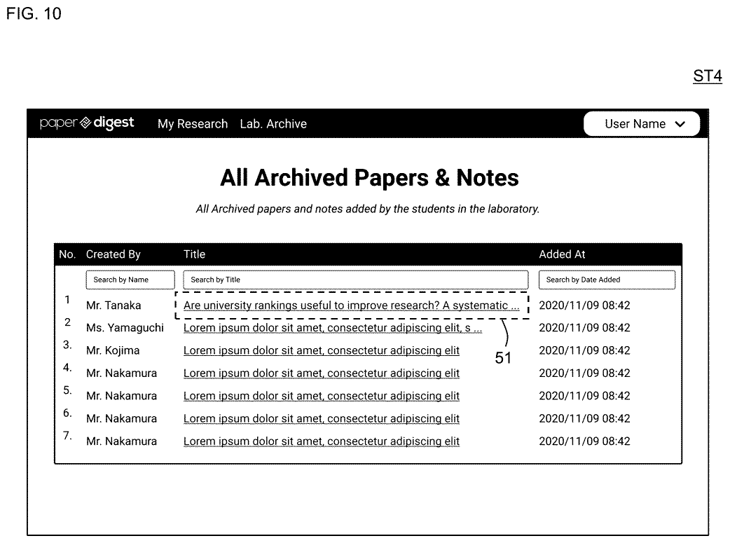

FIG. 10 illustrates an archive list screen ST4. In the archive list screen ST4, a list of notes added to the archive is displayed. The notes added to the archive are allowed to be shared among the team and to be browsed from any member in the laboratory. Such a configuration allows the user U2 as the supervisor to save time and effort of repeating the same instruction in the environment, such as a university, where students are replaced every year.

In the archive list screen ST4, when a title link 51 is pressed, one of the notes added to the archive is displayed.

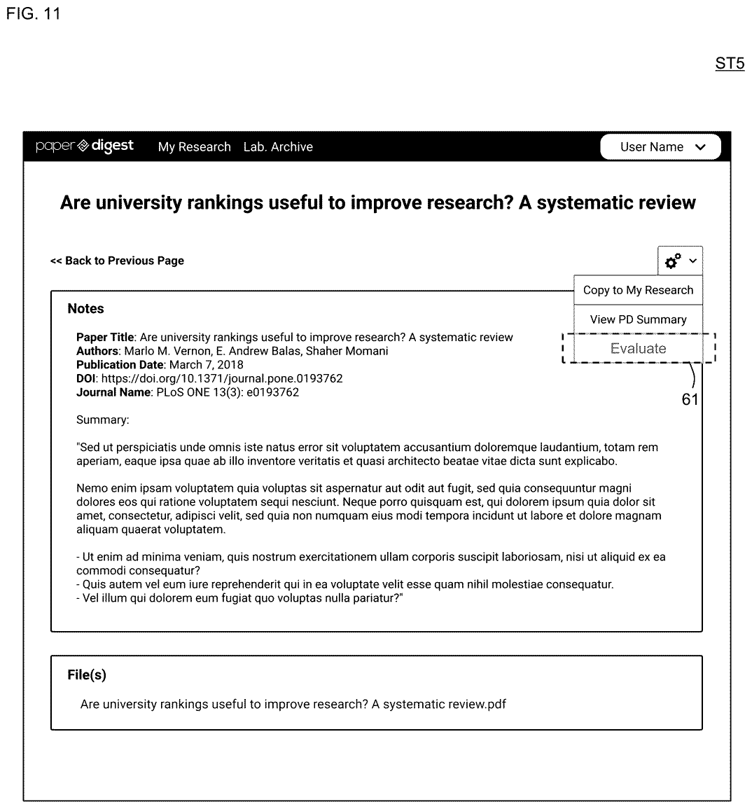

FIG. 11 illustrates an archive check screen ST5. The archive check screen ST5 displays the note added to the archive. The archive check screen ST5 is provided with a note evaluation button 61. The user U1 is allowed to make evaluation on the note by pressing the note evaluation button 61.

In such a manner, it is possible to specify a student that produced useful record in the laboratory by evaluating the recorded data (i.e., notes) shared among the laboratory from the members. For example, a corporate recruiter is capable of finding a student that produced more highly evaluated notes as a prospective employee with priority by referring to the evaluation made on the notes in the archive.

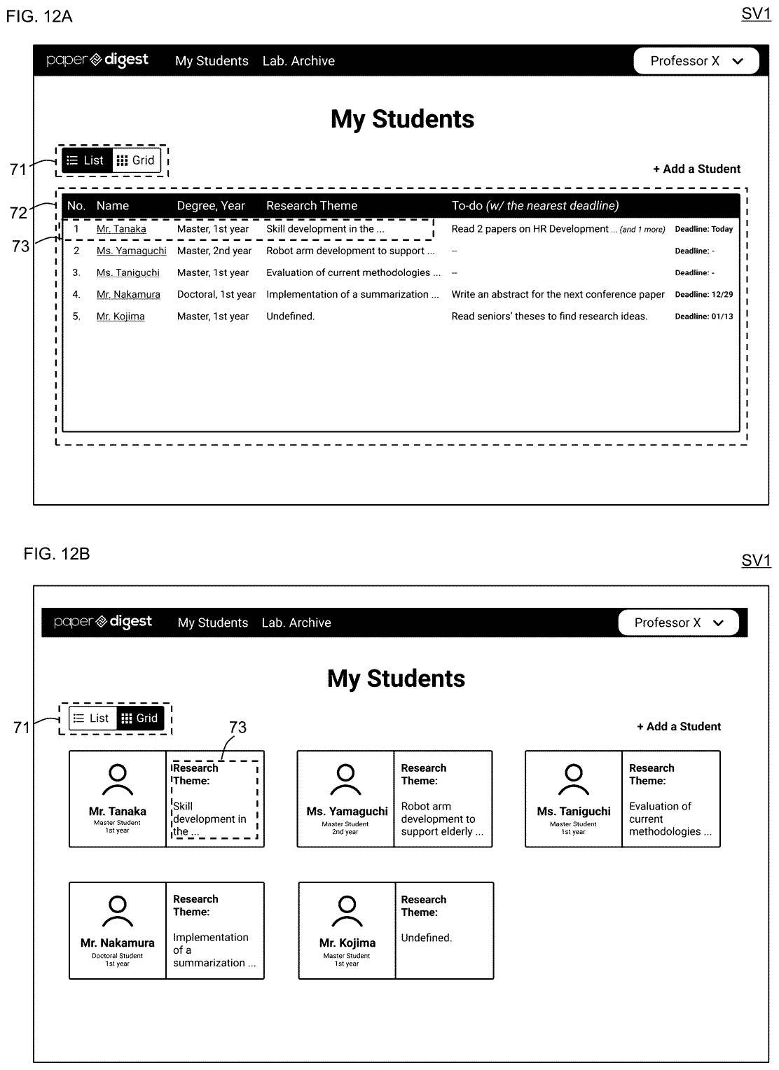

Then, with reference to FIGS. 12A through 15, the case that the user U2 as the supervisor signs in is described.

FIGS. 12A and 12B illustrate a student list screen SV1 as the top screen when the user U2 as the faculty signs in. The student list screen SV1 is provided with a display switch button 71 and a task list area 72. The user U2 is capable of switching the form of displaying the students supervised by the user U2 between a list (FIG. 12A) and a grid (FIG. 12B) by operating the display switch button 71.

In the task list area 72, the most recent task for each student in the laboratory are displayed in a list. Such a specification allows the user U2 as the faculty to readily understand the situation of the tasks of the own students. When a student link 73 in the task list area 72 is pressed, the user U2 is capable of checking on the progress in the research of each student.

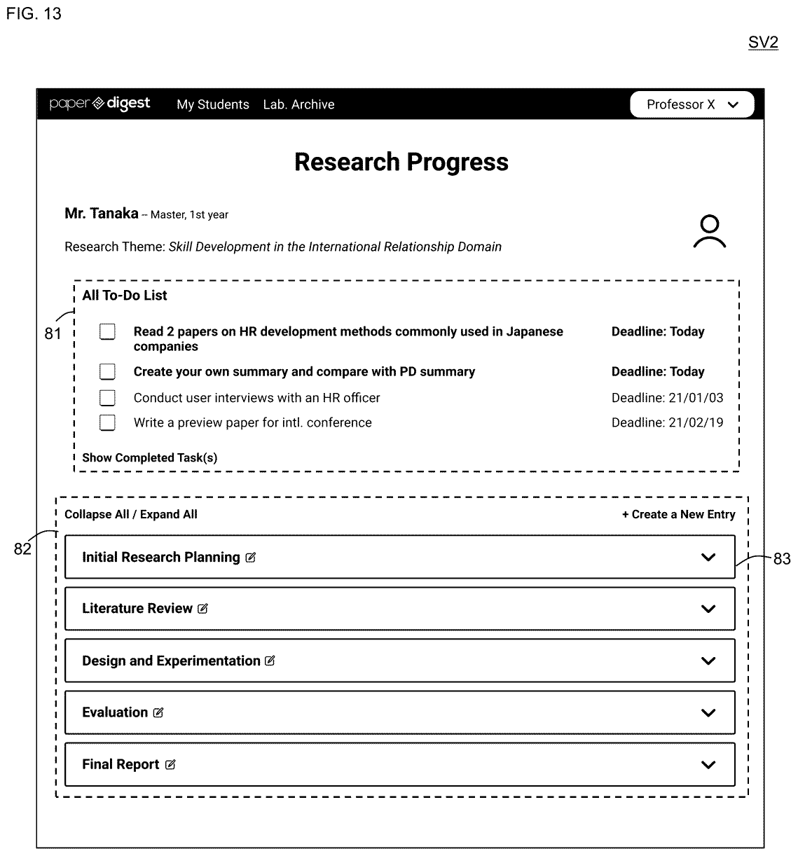

FIG. 13 illustrates a progress check screen SV2. The progress check screen SV2 corresponds to the My Research screen ST1 and is provided with a task list 81 and a phase area 82. In the phase area 82, a plurality of phase icons 83 are displayed. When one of the phase icons 83 is pressed, the details of the phase icon 83 are displayed.

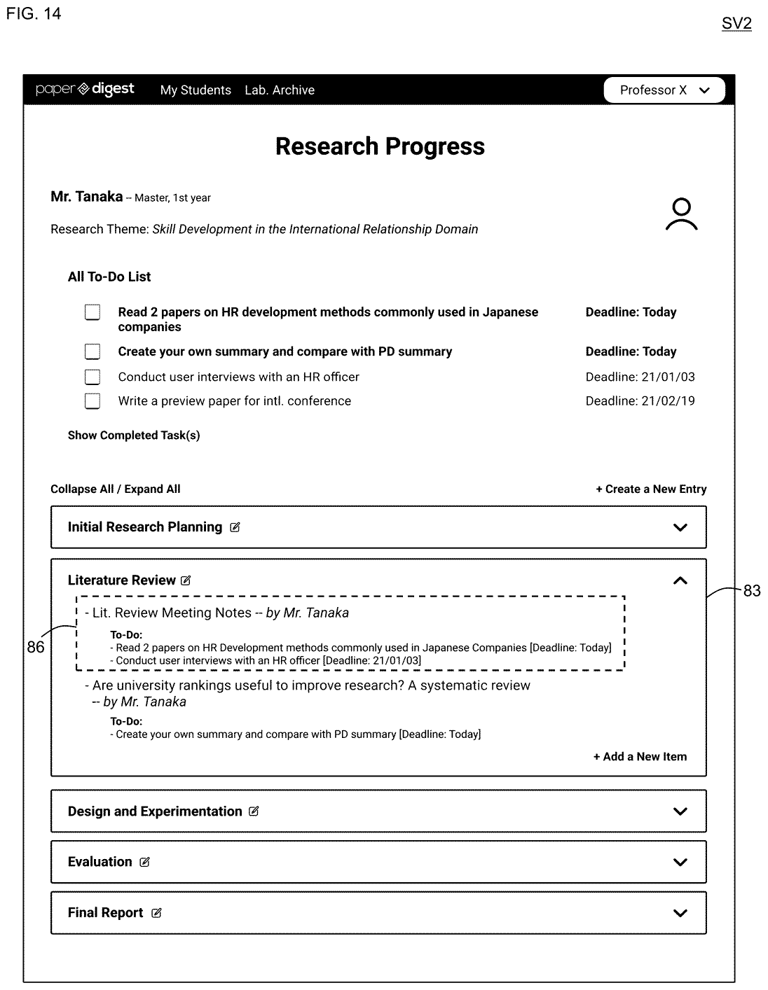

FIG. 14 illustrates a display of the details of one of the phase icons 83 in the progress check screen SV2. The phase icon 83 includes a note icon 86. When the user U2 presses the note icon 86, the details of the note are displayed.

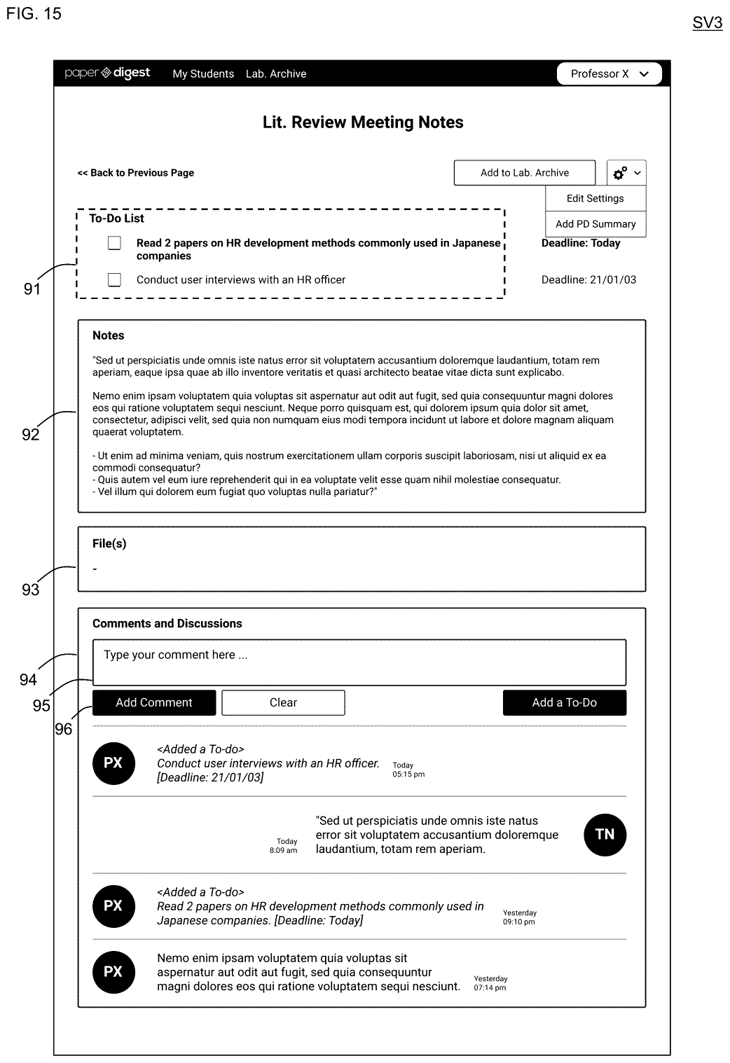

FIG. 15 illustrates a note display screen SV3. The note display screen SV3 corresponds to the note display screen ST2 and includes a task area 91, a note area 92, a file area 93, and a comment area 94.

The user U1 is capable of adding a comment at any time by checking on the contents of the note area 92 and the contents of the comment area 94, followed by entering a comment in a comment input field 95 and pressing an addition button 96.

### 1-5. Process Flow of Information Management System 100

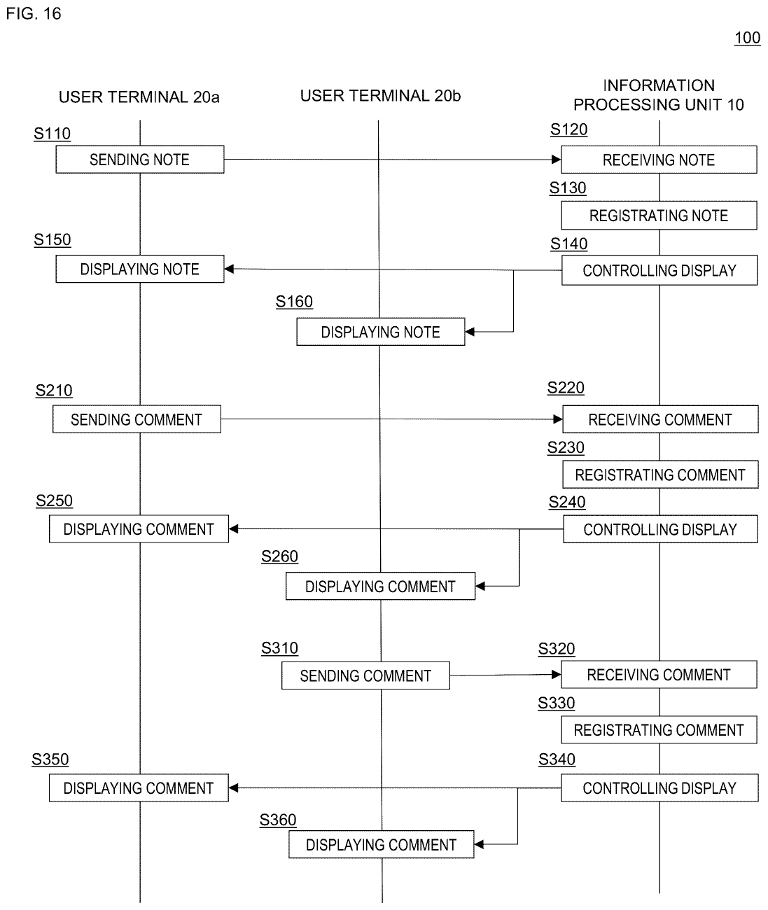

With reference to FIG. 16, a description is given to a process flow of the information management system 100. FIG. 16 is a chart exemplifying a flow of a part of the process of the information management system 100.

At step S110, the user U1 operates the terminal 20a to input recorded data (note) and transmit to the information processing unit 10. At step S120, the information processing unit receives the recorded data.

At step S130, the information processing unit 10 registers the recorded data in the storage section 12. At step S140, the display control section 11b performs control to display the registered recorded data on the user terminals 20a and 20b.

At step S150, the user U1 operates the terminal 20a to cause the terminal 20a to display the recorded data registered in the storage section. In addition, at step S160, the user U2 operates the terminal 20b to cause the terminal 20b to display the recorded data registered in the storage section.

At step S210, the user U1 operates the terminal 20a to input a comment and transmit to the information processing unit 10. At step S220, the information processing unit 10 receives the comment.

At step S230, the information processing unit 10 registers the comment in the storage section 12. At step S240, the display control section 11b performs control to display the registered comment on the user terminals 20a and 20b.

At step S250, the user U1 operates the terminal 20a to cause the terminal 20a to display the comment registered in the storage section. In addition, at step S260, the user U2 operates the terminal 20b to cause the terminal 20b to display the comment registered in the storage section.

At step S310, the user U1 operates the terminal 20a to input a comment and transmit to the information processing unit 10. At step S320, the information processing unit 10 receives the comment.

At step S330, the information processing unit 10 registers the comment in the storage section 12. At step S340, the display control section 11b performs control to display the registered comment on the user terminals 20a and 20b.

At step S350, the user U1 operates the terminal 20a to cause the terminal 20a to display the comment registered in the storage section. In addition, at step S360, the user U2 operates the terminal 20b to cause the terminal 20b to display the comment registered in the storage section.

### 1.6 Modifications

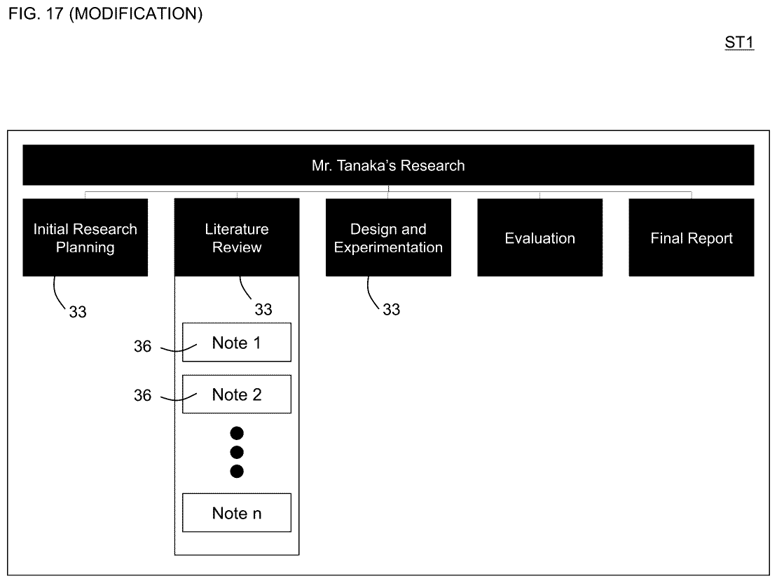

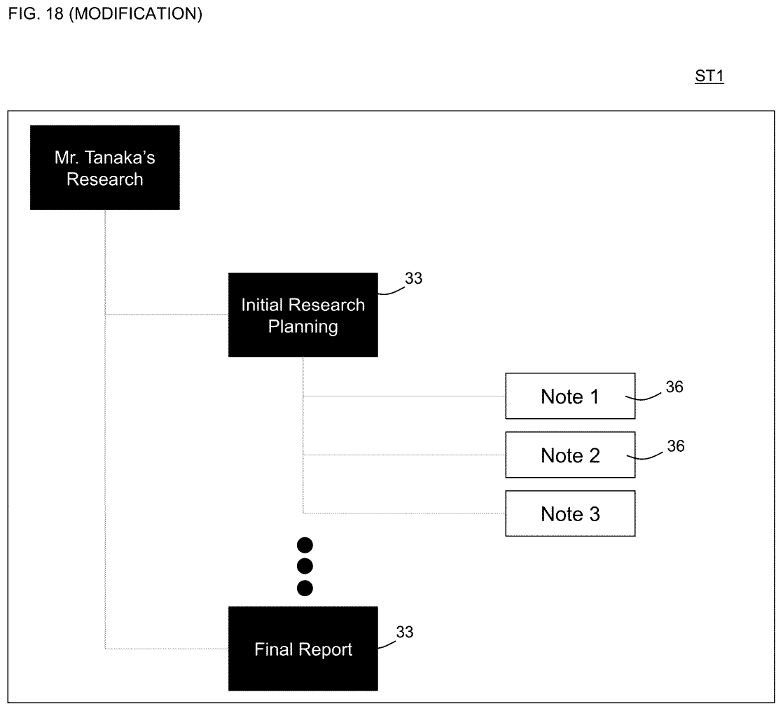

With reference to FIGS. 17 through 19, a description is given to modifications of the My Research screen ST1. In the first modification illustrated in FIG. 17, the phase icons 33 representing the research phases are arranged horizontally in a row, and the associated note icons 36 are displayed vertically in alignment below one of the phase icons 33. In the second modification illustrated in FIG. 18, the tree structure of the phase icons 33 and the note icons 36 is displayed more distinctly.

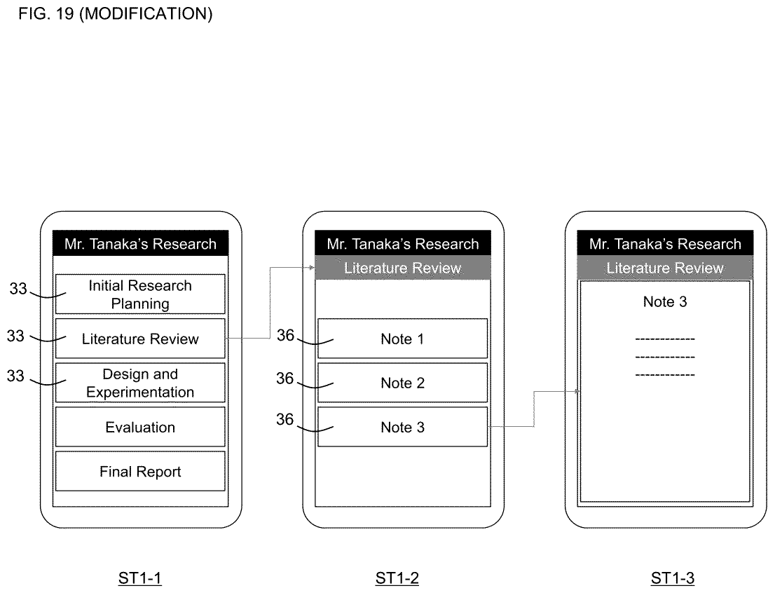

The third modification illustrated in FIG. 19 are screens on the assumption of display on a mobile terminal, such as a smartphone. In the third modification, the My Research screen ST1 is configured from three drawings of ST1-1 through ST1-3 and has a specification to display the associated note icons 36 by pressing one of the phase icons 33 arranged on the screen. As just described, the note icons 36 may be displayed in a tree structure associated with the phases representing the phase icons 33 and may be achieved by various embodiments including the specifications described above.

### 2. OTHER EMBODIMENTS

The present invention has been described with reference to the above embodiment and its modifications while applications of the present disclosure are not limited to the contents described above.

In addition, the above embodiment describes that the information management system 100 is provided with the function of the control section 11 while a part of the function may be implemented by other information processing units. An example of such a specification may include the function of the display control section 11b to be implemented by the user terminals to cause the recorded data registered in the storage section 12 to be displayed on the display screens 24 of the user terminals 20.

Moreover, the present invention may be achieved by a program to cause a computer to achieve the function of the information management system 100 described above.

Furthermore, the present invention may be achieved by a computer-readable non-transitory storage medium that stores the program.

Although various embodiments according to the present invention have been described above, they are merely given as examples and are not intended to limit the scope of the invention. These novel embodiments may be carried out in various other modes and various kinds of omission, substitution, and modification are allowed as long as not departing from the spirit of the invention. Such an embodiment and modifications thereof are included in the scope and spirit of the invention and also included in the scope of the invention described in the claims and their equivalents.

### REFERENCE SIGNS LIST

10: Information Processing Unit, 11: Control Section, 11a: Data Registration Section, 11b: Display Control Section, 11c: Comment Receiving Section, 11d: Evaluation Receiving Section, 11e: Summary Generating Section, 12: Storage Section, 13: Communication Section, 14: Operation Input Section, 15: Monitor, 16: System Bus, 20: User Terminal, 21: Control Section, 22: Storage Section, 23: Communication Section, 24: Display Screen, 25: Speaker, 26: Microphone, 27: Camera, 28: Operation Button, 29: System Bus, 100: Information Management System

1. An information management system to manage information on projects in a team, the system comprising: a storage section; a display screen; a data registration section; and a display control section, wherein
the data registration section is configured to register data on a plurality of phases chronologically proceeding in each project conducted by a respective member in the team in association with recorded data recorded by the member for the respective phases in the storage section, and
the display control section is configured to display the recorded data on the display screen in a tree structure associated with the phases.

2. The information management system according to claim 1, further comprising a comment receiving section, wherein
the comment receiving section is configured to receive a comment on the recorded data from a person in charge of the project and a comment on the recorded data from a supervisor supervising the project.

3. The information management system according to claim 1, wherein
the recorded data is shared among the team.

4. The information management system according to claim 1, wherein
the recorded data includes a task to be performed by the person in charge of the project in the phase associated with the recorded data.

5. The information management system according to claim 4, wherein
the display control section displays a list of the task in the project.

6. The information management system according to claim 5, wherein
the display control section chronologically displays a list of the task for each person in charge.

7. The information management system according to claim 5, wherein
the display control section displays a list of a most recent task for each person in charge of the project.

8. The information management system according to claim 1, further comprising an evaluation receiving section, wherein the evaluation receiving section is configured to receive evaluation on the recorded data from the members in the team.

9. The information management system according to claim 1, further comprising a summary generating section, wherein the summary generating section is configured to generate a summary of a literature specified by the members.

10. A program causing a computer to function as an information management system to manage information on projects in a team, the program causing the computer to execute the steps comprising: data registration and screen control, wherein
the data registration step is configured to register data on a plurality of phases chronologically proceeding in each project conducted by a respective member in the team in association with recorded data recorded by the member for the respective phases in a storage section of the computer, and
the screen control step is configured to display the recorded data on a display screen of the computer in a tree structure associated with the phases.

11. An information processing method causing a computer to function as an information management system to manage information on projects in a team, the method causing the computer to execute the steps comprising: data registration and screen control, wherein
the data registration step is configured to register data on a plurality of phases chronologically proceeding in each project conducted by a respective member in the team in association with recorded data recorded by the member for the respective phases in a storage section of the computer, and
the screen control step is configured to display the recorded data on a display screen of the computer in a tree structure associated with the phases.
